(19) United States
(12) Patent Application Publication
(10) Pub. No.: US 2026/0242158 A1
(43) Pub. Date: Aug. 20, 2026

(54) DISTRIBUTION SYSTEM FOR BULK MATERIALS

(71) Applicant: MAIN TECH S.R.L., San Giorgio Delle Pertiche (IT)

(72) Inventors: Renato PEGORARO, Cadoneghe (IT); Stefano ROSTIN, San Giorgio Delle Pertiche (IT)

(21) Appl. No.: 19/159,300

(22) PCT Filed: Mar. 13, 2024
(86) PCT No.: PCT/IB2024/052406

§ 371 Date: Aug. 22, 2025

(30) Foreign Application Priority Data
Mar. 14, 2023 (IT) 102023000004698

(51) Int. Cl. B65G 53/56; B65G 53/52; B65G 53/54

(52) U.S. Cl. CPC B65G 53/56; B65G 53/521; B65G 53/54; B65G 2201/042

(57) ABSTRACT

A distribution system for feeding material stored in a plurality of storage tanks to one or more processing machines. The storage tanks are connected to the distribution system by means of first flexible tubes, and the distribution system in turn is connected to the processing machine by means of second flexible tubes. The distribution system implements a dual pantograph device comprising two plates (10, 20), adapted to selectively connect the storage container with the corresponding processing machine. The dual pantograph device is placed horizontal, i.e., with planes (T, T1) containing the plates (10, 20) parallel to the support surface. Such a horizontal arrangement of the dual pantograph allows the shaking of the heads of the first flexible tubes to be made efficient with quick movements of the pantographs along the two axes, allowing the material stuck in the coils of the first flexible tubes to be more easily removed by the suction prior to making a change and switching to feeding the processing machine with another material. The dual pantograph device comprises two plates (10, 20) with holes (100, 200), each mounted on a load-bearing structure (P1, P2), in which each plate (10, 20) has a plurality of openings (100, 200). The load-bearing structures (P1, P2) allow the alignment of an opening (100) of the first plate (10) and an opening (200) of the second plate (20) to selectively connect, by means of a connection element (70), the storage container with the corresponding processing machine.

### FIELD OF THE INVENTION

The present invention relates to the field of equipment and lines for storing, dosing and feeding powder and granule materials for plastic, rubber, food and pharmaceutical fields.

The present invention in particular relates to a distribution unit for the automated selective connection between a plurality of storage containers and a plurality of processing machines.

### PRIOR ART

Current plastic material molding plants have a distribution manifold for automated selective connection of a plurality of storage containers with a plurality of molding machines.

The plants therefore have a plurality of molding or processing machines, each of which is fed by a hopper for loading plastic material granules. The hoppers are in turn connected to a corresponding storage container. Thus, there will be various connections with flexible tubes capable of connecting the storage containers to the processing and use machines.

In general, the distribution systems in the prior art are mechanical systems which allow feeding different types of starting materials on a given number of receiving stations located along a line for transforming the product, or obtaining a material to be used for subsequent processing.

In particular, distribution units for dosing and feeding the material contained in a plurality of storage containers to a plurality of processing machines, have been studied and manufactured.

Certain processing operations considered in this field comprise preparing mixtures in the food industry, creating rubber or plastic compounds, and feeding extrusion processes.

All companies in the field have internally developed or acquired partners that develop this type of mechanical systems or distribution units which are fundamental for compacting the dimensions of the plants and curbing costs.

The alternative to using such mechanical systems or distribution units is directly connecting all sources of material (i.e., each storage container) to each point of use (processing machine), thereby multiplying the number of lines and intercepting systems.

The invention described in document DE 4224408 C1 relates to a deflector for a pneumatic device for transporting sliding bulk goods, in particular grit with varying particle size and composition, such as plastic granules, PVC powder, farm products, food granules or chemical/pharmaceutical products.

As shown in FIG. 1, document DE 4224408 C1 describes a distribution system where the material comes from a number “n” of storage tanks. The storage tanks are in turn put in connection, through flexible tubes coupled vertically to a series of coupling heads, with a coupling element to allow the passage of material by means of pneumatic pistons.

This system does not ensure powder or granules of a first material, which inevitably remain in the coils of the corrugated tubes following the change of material with a second, different material in the upstream tank, will not contaminate the new product, with the consequent need to discard the first part of the new production relative to the second material due to defects that may be either in composition or simply aesthetical defects.

The image in FIG. 2 shows an example of defects due to the material in an extruder being contaminated. As shown, the bar made by the machine immediately after the change of material has a different shape and color, making the bar non-homogeneous and to be discarded. Indeed, such a bar was made with the second material, but this second material brought with it in the passage portions of the first material that remained in the corrugated tubes.

Document EP0995703A1 discloses a similar embodiment, where the movement system of the interconnecting tubes between circuits receiving material from the storage containers and tubes sending to the process, substantially changes (see the images shown in FIG. 3).

The problem of material stagnating in the tubes and interconnecting area occurs also in this case.

Further, the choice of a circular-type structure results in a limitation in the number of possible connections because it is possible to install a limited number of inlets/outlets along the circumference, unless the dimensions of the apparatus are significantly increased.

In the past, certain manufacturers replaced the traditional coiled tubes with smooth tubes in order to eliminate or reduce the problem of contamination during changes, however the result was not encouraging because this type of tubes does not withstand as well the repeated stresses, with consequent frequent breaks and stops of the production line.

The Applicant has implemented the pantograph system in its machines which allows the number of ducts in input/output to be increased, with a much smaller increase in the dimensions of the device with respect to those of other systems.

The following link contains a video of a distribution system of the Applicant showing the system actually in operation:
https://www.maintechsrl.com/prodotti-in-evidenza/#lg=1&slide=0.

FIGS. 4, 5 and 6 show certain details of the distribution system of the machine shown in operation in the aforesaid video.

In particular, the Figures show the automated selection system of the material to be fed to the processing machines.

With reference to FIG. 4, the right-hand part of the image shows a first plate with holes with which some flexible corrugated tubes are connected or engaged.

These corrugated tubes are then connected, at a first end thereof, to the plate, and at the second end thereof, to the storage tanks.

The automated material selection system then comprises a second plate with holes to which other corrugated tubes for distributing the material to the different processing machines, are in turn connected.

The two plates with holes face each other and are spaced apart and create the pantograph system.

Each rectangular-shaped plate has a plurality of through openings. Such through openings in this case are circular and are arranged in rows and columns on the surface of the plate. In the machine shown in the video and in FIGS. 4, 5, and 6 in particular, the openings on each plate are arranged over five rows and five columns.

Each opening is provided with a bushing or annular sealing gasket, made of rubber, for example.

The two plates with holes are each mounted on a motorized slide activated by actuators and capable of moving with respect to the frame in a portal load-bearing structure. The two slides allow moving the two plates independently to ensure the two openings to be connected may be aligned and coupled by means of a connection element. In particular, the slides are moved until the two openings are coaxial. The slides, movable on the frame, allow a pantograph or link quadrangle movement by positioning the two plates in order to create the required passages. The slides on which the plates are mounted may therefore vertically and horizontally translate to position the respective openings so that they are aligned and so as to selectively connect the storage container with the corresponding processing machine. Further, the slides may be moved to distance or near the two plates. During the alignment step, the plates are further distanced and once the desired position is reached, the plates are neared to put the flexible tubes in communication.

Each plate thus has two faces, a first face facing inwards and facing the other plate, and a second outer face adapted to be coupled with the plurality of corrugated tubes. Therefore, between the plate and the corrugated tube, there is a connection element that may be a joining and locking ring or a connector.

Naturally, the corrugated tubes are flexible and allow the movement of the slides to obtain the desired connections.

Further, in a centralized transport system, the receivers of the material may be for granules, flakes or powder. The unloading of material may be of the swinging type check valve, with a pneumatic throttle valve, radial valve, or free for cyclone systems.

Centralized systems are employed in injection, extrusion, blowing, in the production of rubber, in compound, in PVC lines, etc.

### SUMMARY OF THE INVENTION

The object of the invention has been achieved by a distribution system for feeding material stored in a plurality of storage tanks to one or more processing machines, in which the storage tanks are connected to the distribution system by means of first flexible tubes, and in which the distribution system in turn is connected to the processing machine by means of second flexible tubes. The distribution system implements a dual pantograph device comprising two plates adapted to selectively connect the storage container to the corresponding processing machine. The dual pantograph device is placed horizontal, i.e., with the planes containing the plates parallel to the support surface. Said horizontal arrangement of the dual pantograph allows the shaking of the heads of the first flexible tubes to be made efficient with quick movements of the pantographs along the two axes, allowing the material stuck in the coils of the first flexible tubes to be more easily removed by the suction prior to making a change and switching to feeding the processing machine with another material.

Further, a series of highly complex and costly movements of the delivery or unloading tubes actuated with pneumatic pistons or other mechanical or electrical systems is eliminated with the solution proposed by the Applicant.

### BRIEF DESCRIPTION OF THE FIGURES

Reference is made later in this description to the drawings in the accompanying drawings, in which:

FIGS. 1-3, described above, relate to solutions proposed in the prior art;

FIGS. 4-6, described above, relate to solutions currently employed by the Applicant;

FIGS. 7-14 relate to the solution herein proposed.

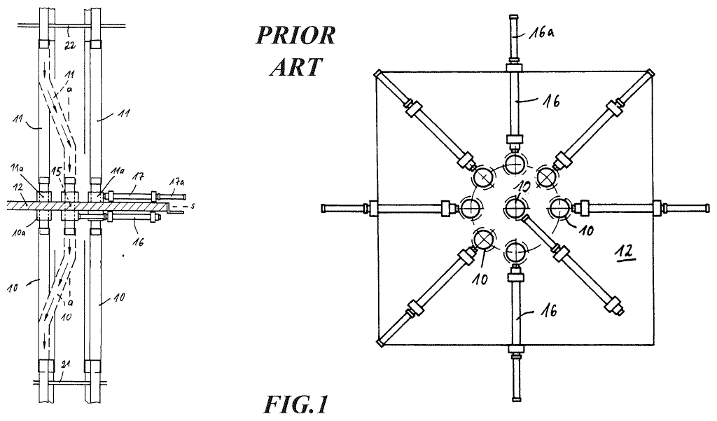

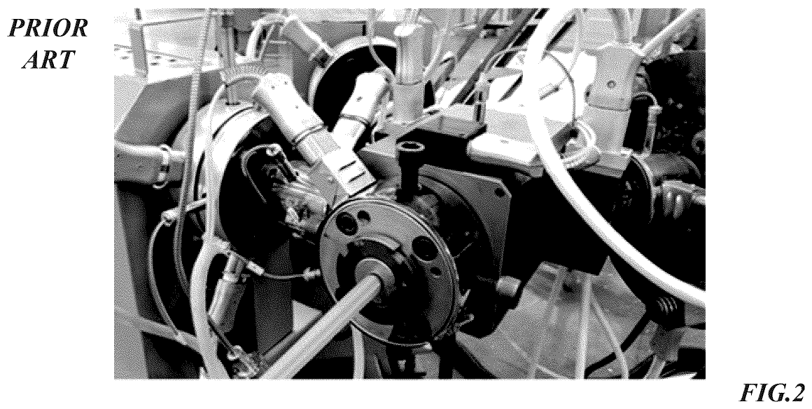

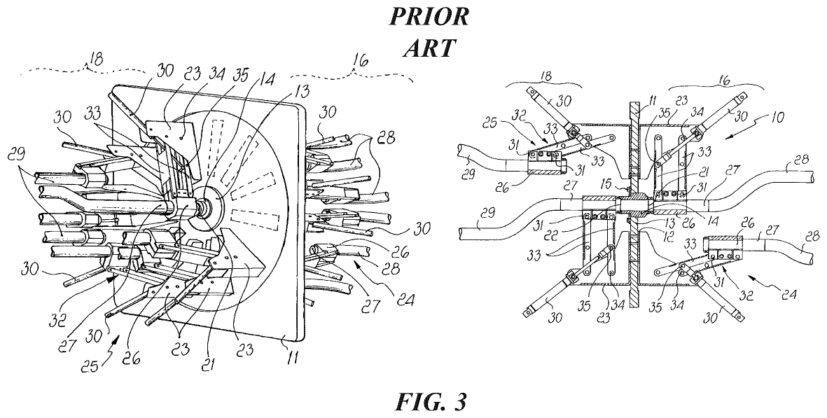

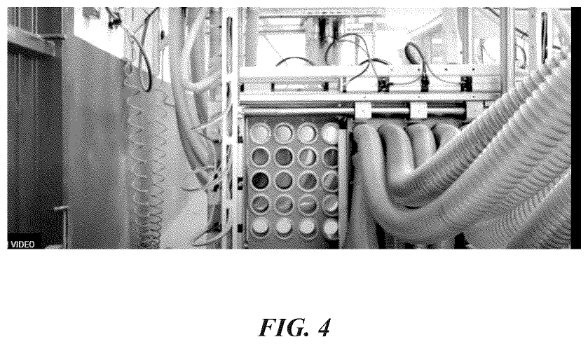

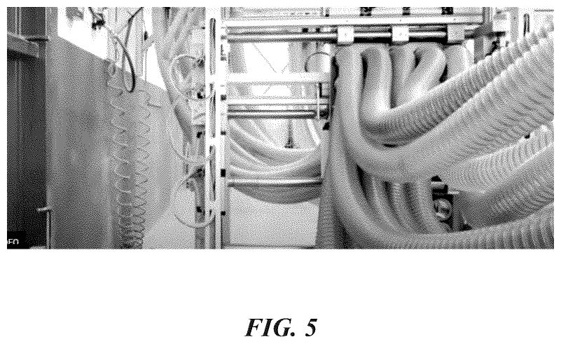

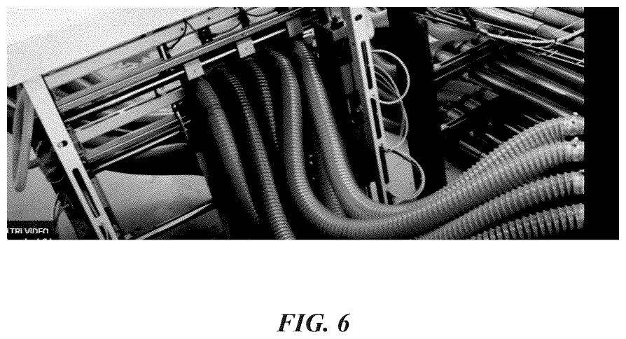

The parts according to the present description have been represented in the drawings, where appropriate, with conventional symbols, showing only those specific details which are pertinent to understanding the embodiments of the present invention, so as not to highlight details which will be immediately apparent to those skilled in the art, with reference to the description provided below.

### DETAILED DESCRIPTION OF THE INVENTION

The solution of the present invention is now described with the aid of the drawings.

The dual pantograph configuration is kept in the new configuration here proposed, both for construction simplicity and reliability.

As may be understood from the video, the configuration with the two plates, where the vertically facing material arrival and starting tubes are fastened, does not allow the absence of residual granules which stop in the coils of the tubes to be ensured.

Further, with respect to competing systems, the speed with which the pantograph moves would result in these stuck granules being capable of moving and falling into the connection system during the movement steps.

The combined use of suctioning and shaking the delivery plates (which is possible precisely due to the use of the pantograph technology) reduces, but does not entirely eliminate, the problem.

The Applicant has decided to modify its system to solve the problem by making the following improvements.

Firstly, the dual pantograph was placed from vertical to horizontal. This allows the shaking of the tube heads to be made much more efficient with quick movements of the pantographs along the two axes and/or with cleaning air jets, allowing the granules stuck in the coils to be more easily removed by the suction prior to making a configuration change and switching to another material.

Secondly, a mechanical gate activated by a pneumatic piston for closing the connection element between the two plates was added. This gate is closed prior to changing the configuration and reopened only upon completion of the movement for cleaning the residues of the preceding material to prevent accidental contamination. Thereby, any residual material belonging to the first type is blocked and suctioned and does not go further into the feeding section of the processing machine.

Lastly, both the gate and the support plane of the interface element or connection element are made with tilted planes to allow any granules or residual powder falling from the delivery tubes to be removed from the area of the two pantographs and collected in suitable tanks for the subsequent removal or elimination. Further, such a connection element serves as an umbrella for the connections placed on the underlying plate, to prevent the granules of material or powder which may be detached from the connections of the upper plate from falling onto the underlying one, with contamination problems.

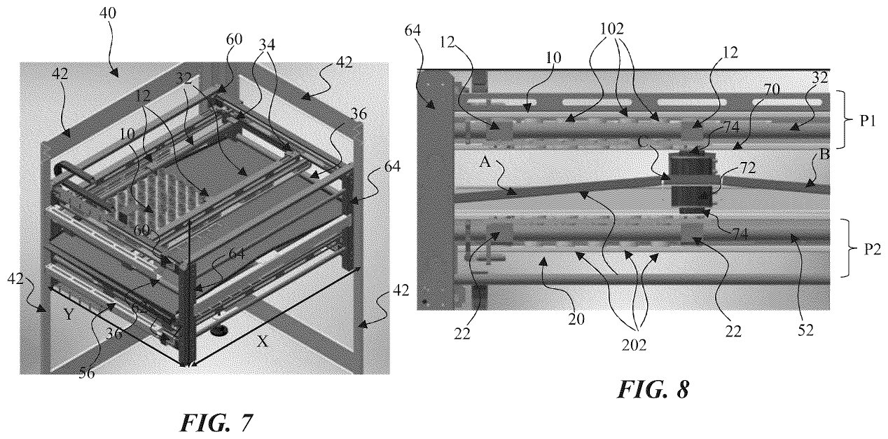

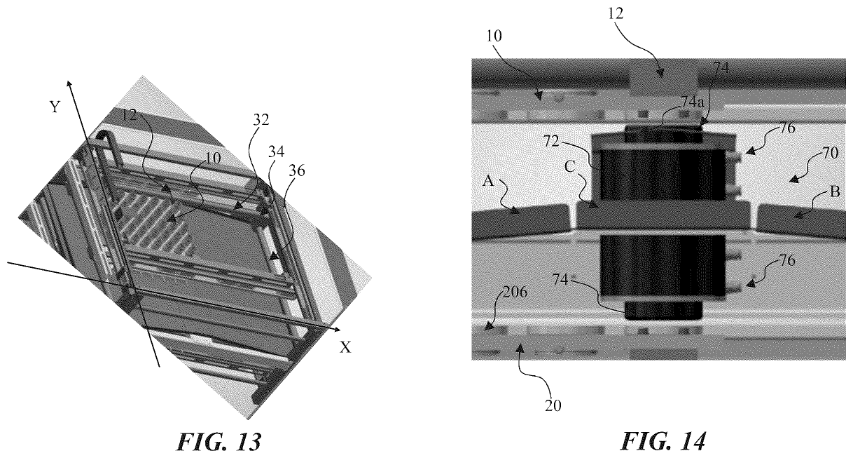

In particular, the solution is described in detail with reference to FIGS. 7-14.

As shown in the figures, in this case the frame on which the slides carrying the plates are mounted is horizontally arranged. In the preceding solutions however, the frame was vertically arranged.

With reference to FIG. 7, it shows a first plate 10 (also called upper plate with respect to the arrangement of the system). Such a first upper plate 10 is adapted to be connected to the delivery tubes (not shown in the drawings to simplify and facilitate the description). Such delivery tubes have a first end connected to said first plate 10 and a second end connected to a storage container.

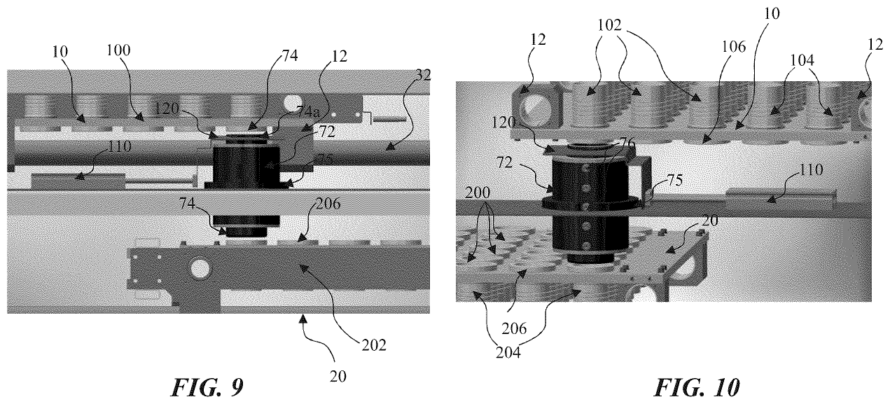

In a symmetrical manner, there is a second plate 20 (also called lower plate—see FIGS. 8 and 9). Such a second lower plate 20 is adapted to be connected to the distribution tubes for sending the materials to the processing machine (these also not shown in the drawings to simplify and facilitate the description). Such distribution tubes have a first end connected to said second plate 20 and a second end connected to the processing machine.

For the following description, imagine looking at FIG. 7 from above, i.e., from a plane parallel to the transverse plane T containing the first upper plate 10. Refer also to FIG. 13 in which the Cartesian axes in the transverse plane T are aligned with frame 40.

Frame 40 is made of profiled support sheets 42 arranged to make a box-like structure.

Plate 10 is mounted on a load-bearing structure P1 in which said load-bearing structure P1 allows the pantograph movement thereof.

The first plate 10 is mounted sliding on slides or shoes 12 which allow the movement thereof with respect to the support frame 40.

In particular, the slides 12 are mounted sliding on first horizontal guide bars 32. The movement of the slides 12 on the first horizontal guide bars 32 allows the movement in direction X shown in the drawings. In particular, the slides 12 allow the translation of the upper plate 10 to the right and to the left inside frame 40 in the transverse plane T.

The first horizontal bars 32 in turn are mounted sliding on second horizontal guide bars 36 by means of slides or shoes 34. The movement of the slides 34 on the second horizontal bars 36 allows the movement in direction Y indicated in the drawings.

The slides or shoes 12 and 34, the first horizontal guide bars 32 and the second horizontal guide bars 36 create the load-bearing structure P1 of the first plate 10.

The second plate 20 is arranged on a transverse plane T1 parallel to and spaced apart from plane T which accommodates the first plate 10.

The lower plate 20 is mounted on a load-bearing structure P2 in which said load-bearing structure P2 allows the pantograph movement thereof.

Similarly, also the second plate 20 is mounted sliding on slides or shoes 22 which allow the movement thereof with respect to the support frame 40.

In particular, the slides 22 are mounted sliding on third horizontal guide bars 52. The movement of the slides 22 on the third horizontal bars 52 allows the movement in direction X indicated in the drawings. In particular, the slides 22 allow the translation of the lower plate 20 to the right or to the left on the transverse plane T1.

The third horizontal bars 52 in turn are mounted sliding on fourth horizontal guide bars 56 by means of slides or shoes 54. The movement of the slides 54 on the fourth second horizontal bars 56 allows the movement in direction Y indicated in the drawings.

The slides or shoes 22 and 54, the third horizontal guide bars 52 and the fourth horizontal guide bars 56 create the load-bearing structure P2 of the second plate 20.

The distribution system further provides a connection element, indicated by reference numeral 70.

The connection element 70 selectively puts the storage tanks in communication with the processing machines.

Two types of connection elements 70 exist, in particular an active one and a passive one.

In the main embodiment mode, the connection between the two plates 10 and 20 is obtained by means of an active type connection element 70, which consists of an external bushing 80 and two hollow pneumatic cylinders 82 and 84.

The two hollow pneumatic cylinders 82 and 84 are dual effect and extend towards the openings 100 and 200 to connect together the delivery tubes connected to the upper plate 10 and the feeding tubes of the machine connected to the lower plate 20.

In particular, the two hollow pneumatic cylinders 82 and 84 have a bistable behavior and have a first free position, in which they are retracted and are inside the external bushing 80 of the connection element 70, and a second coupling position, in which they are extended and are controlled to exit bushing 80 and connect to the openings 100 and 200 of the plates 10 and 20, respectively.

The two hollow pneumatic cylinders 82 and 84 provide a head gasket 85 at the free ends thereof 82a and 84a to facilitate the coupling with the openings 100 and 200 of the plates 10 and 20.

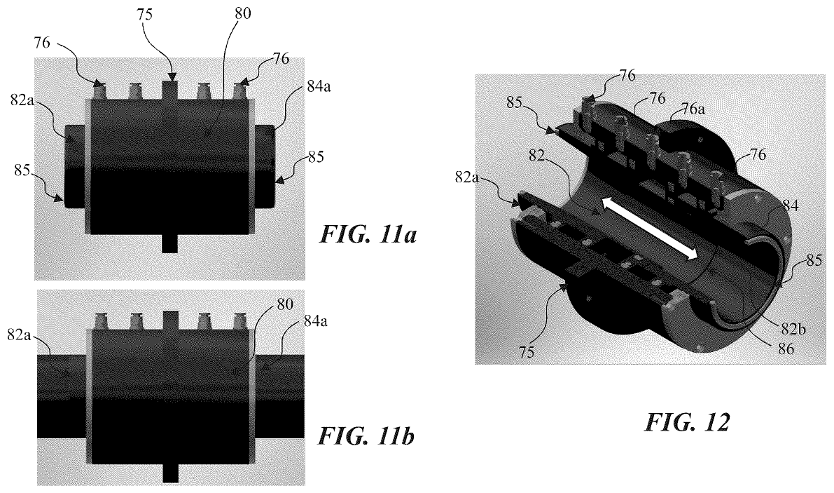

In greater detail, with reference to FIG. 11a, the two hollow pneumatic cylinders 82 and 84 are in the first free position thereof, in which they are retracted and are inside the external bushing 80 of the connection element 70 when the plates 10 and 20 must move for the positioning and alignment of the delivery and feeding tubes.

Otherwise, the two hollow pneumatic cylinders 82 and 84 are in the second coupling position thereof, see FIG. 11b, in which they are extended and project outside the external bushing 80 of the connection element 70 when the plates 10 and 20 are in the correct and aligned position and the connection element 70 allows the passage of material arriving from the delivery tubes towards the feeding tubes of the machine.

As shown in the figures, the connection element 70 further comprises five pneumatic connections 76. In particular, the two outer pneumatic connections 76 on each side allow the movement of the respective cylinder 82 or 84, while the inner pneumatic connection 76a may be used for cleaning the previously fed connection element 70 of the material residues.

With particular reference to FIGS. 11 and 12, they show a side view and a partially sectioned perspective view of the connection element 70. In such figures, the element is shown in horizontal position, but during use, the connection element 70 is positioned vertically, with the cylinders creating the passage portion for the material that moves from the delivery tubes towards the distribution tubes for feeding the processing machines.

As mentioned above, the connection element 70 comprises a tubular external bushing 80 and two bistable inner hollow cylinders 82 and 84. In the first free position thereof, the two bistable hollow cylinders 82 and 84 are retracted inside bushing 80 and only a small portion of the free end thereof 82a carrying the head gasket 85 projects, as shown in FIG. 11a. The sectional view in FIG. 12 shows how cylinder 82 is the innermost and longest with respect to cylinder 84. The joining line 86 indicates the area in which the superposition of the two cylinders 82 and 84 ends. In particular, the terminal end 84b of cylinder 84, opposite to the free end 4a, accommodates therein the terminal end 82b of cylinder 82. In particular, cylinder 82 has a slightly smaller diameter with respect to cylinder 84.

Therefore, during the movement between the first free position and second coupled position (see FIG. 11b), the end portions 82b and 84b of the two cylinders slide on each other due to the activation by means of the external pneumatic connections 76, and at the end of the extension thereof, the cylinders 82 and 84 leave open a chamber inside the external bushing 80 and in communication with the inner pneumatic connection 76a.

Therefore, actuators for activating and extending and/or retracting the cylinders 82 and 84 are provided. Therefore, the actuators allow the movement of the cylinders 82 and 84 between the first free position thereof and the second coupling position thereof, and vice versa.

Naturally, element 70 will be in the first free position thereof with the cylinders 82 and 84 back in the external bushing 80 during the movement of the plates 10 and 20 for the alignment of the delivery tubes with the distribution tubes for feeding to the processing machine so as not to interfere with the movements of the upper 10 and lower 20 plates. Vice versa, element 70 will be in the second coupling position thereof during the passage of the material from the tanks to the processing machines.

In alternative embodiments, the plates 10 and 20 are provided also with the possibility of moving along axis Z, and the connection element 70 is a stationary or passive element provided only with the compressed air connection for cleaning (one or more of the pneumatic connections 76).

In this alternative embodiment of the device, there is provided also a further vertical movement, along axis Z, perpendicular to the transverse planes T and T1, which allows the first plate 10 and the second plate 20 to move toward each other in a first moment to create the connection (through the passive connection element 70) for the transfer of the material, and to move away from each other in a second moment. This distancing of the plates 10 and 20 serves to avoid the interference of the plates 10 and 20 with the connection element 70 during the movements of the plates on the planes T and T1.

In particular, the load-bearing structure P1 of the first plate 10 and the load-bearing structure P2 of the second plate 20 are mounted on respective slides or sliding shoes 60 and 62 that also allow the movement along axis Z of the two load-bearing structures P1 and P2 to achieve the nearing and distancing movements of the plates 10 and 20. The sliding slides 60 and 62 slide in tracks 64 connected to the profiled support sheets 42 of the frame.

Therefore, in this embodiment, after the movements of the plates 10 and 20 in the planes T and T1 to align the tubes and obtain the correct connection between tank and machine, the plates 10 and 20 are neared to each other to be connected to the passive connection element 70.

In this case, there are therefore provided actuators for activating the respective slides or shoes, to obtain the movement of the plates 10 and 20 along the three axes X, Y and Z in order to obtain the correct positioning and the right connection between storage container and processing machine.

Naturally, in the embodiments employing an active connection element 70, there are provided actuators for activating the respective slides or shoes, to obtain the movement of the plates 10 and 20 along the two axes X, Y, while the movement along axis Z is obtained by the cylinders 82 and 84 which move between a first free position, in which they are retracted inside bushing 80, and a second coupling position, in which they are extended and project more from bushing 80.

The embodiment providing the employment of an active connection element 70 is certainly preferable because it simplifies the support structure of the plates 10 and 20 and is the most efficient.

In all the embodiments, the two plates 10 and 20 are both with holes with through openings 100, 200 for the passage of the material. Each through opening 100, 200 comprises a first mouth for the connection with the flexible corrugated tubes and a second mouth for the connection with the connection element 70, whether it is active or passive.

Each rectangular-shaped plate 10 and 20 therefore has a plurality of circular through openings 100, 200 neatly arranged in rows and columns on the surface.

In the exemplary images shown in the figures, the plates 10 and 20 comprise openings arranged over five rows and seven columns (with respect to the defined Cartesian plane).

Each opening 100 and 200 is provided with a bushing or sealing gasket 102 or 202. Such a flanged cylindrical bushing 102 or 202 comprises a main cylindrical body 104 or 204 and a flange 106 or 206 (see FIGS. 8-10).

With reference to FIG. 8, that shows a side view of the distribution system according to the invention, there is a portion of empty space between the two transverse planes T and T1 in which there are arranged two tilted sheets A and B for the removal of any leaks of material.

The two tilted sheets A and B are connected to each other by means of a middle horizontal sheet C.

Sheets A and B are tilted with respect to the horizontal plane by a minimum of 15 and a maximum of 45 degrees, preferably 25 to 30 degrees, and form a kind of chute for collecting the residual material.

Again, with reference to FIG. 8, the first upper delivery plate 10 and the second plate 20 for sending materials to the processing machine are shown.

FIG. 8 also shows the connection element 70 arranged between the first upper plate 10 and the second plate 20. The connection element 70 or interface element is positioned in a through hole obtained in the horizontal sheet C. The connection element 70 is positioned in the middle of frame 40.

Naturally, the connection element 70 is interposed between a first through opening 100 of the upper plate 10 and a second through opening 200 of the lower plate 20.

As already mentioned above, the connection element 70 may be of two types, i.e., passive or active.

In the first embodiment of the connection element 70, i.e., in the case of an active element, it comprises a tubular external bushing 80 and two bistable and extendible hollow cylinders 82 and 84 which slide inside the external bushing 80 to move between two positions.

A second embodiment of the connection element 70 instead provides a passive element in which the element is a single integral piece. In this case, the connection element 70 is a tubular element with a central body 72 of large diameter and two end portions 74 of small diameter that extend cantilevered from the central body 72, with the two end portions 74 adapted to be received in the bushing or annular sealing gasket 102/202 of the through openings 100/200.

In both embodiments, the (active and passive) connection element 70 also has an annular flange 75 adapted to support the connection element 70 in said through hole made in the horizontal sheet C. In particular, the diameter of the annular flange 75 is greater than the diameter of the through hole made in the horizontal sheet C, therefore the connection element 70 is supported by interference.

In the case of an active connection element 70, the annular flange 75 is obtained in the middle of the external bushing 80, while in the case of a passive connection element 70, the annular flange 75 is obtained in the middle of the central body 72.

The connection element 70 is shaped to simplify the passage of the material from the delivery tubes to the feeding tubes of the processing machine.

In particular, the two end portions 74 of small diameter (in the passive case) or the two free ends 82a and 84a (in the active case) are adapted to be coupled with the respective flanges 106 or 206 of the bushings or sealing gaskets 102 or 202 received in the openings 100 or 200.

With reference to FIG. 9, it shows a pneumatic movement piston 110 of a mechanical closure of the connection element 70. The mechanical closure creates the aforesaid gate.

In the case of the embodiment with an active connection element 70, the pneumatic movement piston 110 of the mechanical closure acts on a closing gate 120 which once activated, overlaps mouth 84a of the connection element 70, closing the outlet thereof. Naturally, such a closing operation occurs when cylinder 84 is in the first free retracted position.

In the case of the embodiment with a passive connection element 70, the pneumatic movement piston 110 of the mechanical closure acts on a closing gate 120 (shown in completely closed position in FIG. 9), which enters a slit 74a of the upper end portion 74 of the connection element 70, closing the outlet thereof.

The closing gate 120 creates an angled-profile cover of the mouth, with angle of about 20 degrees. Gate 120 is capable of closing and opening the passage to prevent the contamination of the materials during the change configuration step.

The movement may be obtained alternatively with an electrical servomotor.

Naturally, the closing gate 120 is movable between a first opening position, in which it leaves open the end portion 74 of small diameter, and a second closing position, in which it closes and keeps closed the end portion 74 of small diameter. The movement between the first and second positions occurs by means of said pneumatic movement piston 110.

In the alternative embodiments, when the connection element 70 is active and comprises a tubular external bushing 80 and two bistable hollow cylinders 82 and 84, the pneumatic movement piston 110 of the mechanical closure acts on a closing gate 120 that closes the free end 84a of cylinder 84 when it is in the first free or retracted resting position thereof.

Finally, FIG. 10 also shows the compressed air connections 76 of the cleaning nozzles. Tubes for spraying compressed air for removing the remaining material residues are connected to such compressed air connections 76.

As mentioned above, in a first embodiment, by extending the hollow cylinders, the active connection element 70 allows the connection between the upper plate 10 and the lower one 20.

In the alternative embodiment, i.e., with the passive connection element 70, by moving along the support bars, the slides allow independently moving the two plates 10 and 20 also in axis Z to ensure that the two through openings to be connected may be aligned and coupled by means of the connection element 70.

In particular, the slides are moved in the two axes until the two openings 100 and 200 are aligned and coaxial.

In particular, in a first moment, the plates 10 and 20 are moved in the transverse plane to align them. In this step, the two plates are in the spaced apart condition. In a second moment, once they are aligned in the two planes T and T1, the plates 10 and 20 are neared to each other with movements of the slides 60 and 62 which allow moving the plates 10 and 20 to connect them to the connection element 70.

The slides or shoes may slide on the guide bars and allow a pantograph or joint quadrangle movement by positioning the two plates 10 and 20 at the passive connection element 70 in order to create the passage required for feeding the material from the storage container to the processing machine.

The slides or shoes on which the plates 10 and 20 are mounted may therefore translate vertically and horizontally to position the respective openings 100 and 200 so that they are aligned, and to selectively connect the storage container with the corresponding processing machine.

Then, in a first embodiment, the active connection element 70 moves its two cylinders 82 and 84 to create the connection with the plates 10 and 20.

Alternatively, the passive connection element 70 remains fixed and the slides may be moved to move away or near the two plates 10 and 20. During the alignment step, the plates are further spaced apart, and once the desired position is reached, the plates are neared to put the flexible tubes into communication by means of the connection element 70.

The above description of embodiments of the invention is capable of showing the invention from a conceptual point of view so that others, using the known art, will be able to modify and/or adapt, in various applications, such specific embodiments, without further research and without departing from the inventive concept, and therefore it is understood that such adaptations and modifications will be considered as equivalents of the specific embodiments.

The means and materials for achieving the various described functions can be of various types without departing from the scope of the invention.

The expressions or terminology used are merely intended for descriptive purposes and therefore are not limiting.

Obviously, without prejudice to the principle of the invention, the construction details and the embodiments can widely vary with respect to the above disclosure merely given by way of example, without departing from the scope of the present invention.

Where the constructional features and techniques mentioned in the following claims are followed by references symbols or numerals, such reference symbols were introduced for the sole purpose of increasing the intelligibility of the claims themselves, and accordingly such reference symbols have no limiting effect on the interpretation of each element identified by way of mere example by such reference symbols.

1) A distribution system for feeding material stored in a plurality of storage tanks to one or more processing machines, wherein said storage tanks are connected to the distribution system by means of first flexible tubes, and wherein the distribution system in turn is connected to the processing machine by means of second flexible tubes, wherein the distribution system implements a dual pantograph device comprising two plates (10, 20), adapted to selectively connect the storage container with the corresponding processing machine, wherein said dual pantograph device is placed horizontal, i.e., with planes (T, T1) containing the plates (10, 20) parallel to the support surface, and wherein said horizontal arrangement of the dual pantograph allows the shaking of the heads of the first flexible tubes to be made efficient with quick movements of the pantographs along the two axes, allowing the material stuck in the coils of the first flexible tubes to be more easily removed by the suction prior to making a change and switching to feeding the processing machine with another material.

2) The distribution system according to claim 1, wherein the dual pantograph device comprises two plates (10, 20) with holes (100, 200), each mounted on a load-bearing structure (P1, P2), wherein each plate (10, 20) has a plurality of openings (100, 200), wherein said load-bearing structures (P1, P2) allow the alignment of an opening (100) of the first plate (10) and an opening (200) of the second plate (20) to selectively connect, by means of a connection element (70), the storage container with the corresponding processing machine.

3) The distribution system according to claim 2, wherein the connection between the first upper plate (10) and the second lower plate (20) is made by an active connection element (70) provided with hollow extendible cylinders (82, 84) carried by an external bushing (80), wherein said hollow extendible cylinders (82, 84) are movable between a first free retracted position and a second coupling position in which said hollow extendible cylinders (82, 84) are extended, wherein said hollow extendible cylinders (82, 84) retract to allow the movement of the plates (10, 20) on the plane (X, Y) and extend to create the connection between the first upper plate (10) and the second lower plate (20).

4) The distribution system according to claim 1, wherein the connection between the first upper plate (10) and the second lower plate (20) is made by a passive connection element (70), where the connection element (70) is a neutral and fixed element and the connection between the first upper plate (10) and the second lower plate (20) occurs by means of the movement along the vertical axis (Z) of the two plates (10, 20).

5) The distribution system according to claim 2, wherein the connection element (70) is further provided with a closing gate (120) which is movable between a first opening position, in which it leaves open the passage of the connection element (70), and a second closing position, in which it closes and keeps closed the passage of the connection element (70).

6) The distribution system according to claim 5, wherein the movement of said closing gate (120) between the first and the second positions occurs by means of a pneumatic movement piston (110).

7) The distribution system according to claim 2, wherein said load-bearing structure (P1) of the first plate (10) comprises first slides (12) sliding on first horizontal guide bars (32) and first slides (34) sliding on second horizontal guide bars (36), and said load-bearing structure (P2) of the second plate (20) comprises third slides (22) sliding on third horizontal guide bars (52) and fourth slides (54) sliding on fourth horizontal guide bars (56).

8) The distribution system according to claim 2, wherein said connection element (70) is supported by a middle horizontal sheet (C) comprised between two tilted sheets (A, B) for removing any leaks of material, wherein said tilted sheets (A, B) form a kind of chute for collecting and eliminating the residual material.

9) The distribution system according to claim 8, wherein the two tilted sheets (A, B) are tilted with respect to the horizontal plane by a minimum of 15 and a maximum of 45 degrees, preferably in a range between 25 and 30 degrees.

10) The distribution system according to claim 2, wherein the connection element (70) comprises compressed air connections (76) for the cleaning nozzles to spray compressed air to remove the material residues remained in the connection element (70).
